(19) United States
(12) Patent Application Publication
(10) Pub. No.: US 2004/0252959 A1
(43) Pub. Date: Dec. 16, 2004

(54) Junction box

(76) Inventors: Sigekazu Kawai, Gunma (JP); Tsutomu Ishikura, Gunma (JP)

Correspondence Address: MCGINN & GIBB, PLLC, 8321 OLD COURTHOUSE ROAD, SUITE 200, VIENNA, VA, 22182-3817, US

(21) Appl. No.: 10/487,201

(22) PCT Filed: Aug. 19, 2002
(86) PCT No.: PCT/JP02/08360

(30) Foreign Application Priority Data
Aug. 22, 2001 (JP) 2001-251525

(51) Int. Cl. G02B 6/00

(52) U.S. Cl. 385/135

(57) ABSTRACT

A temperature recording part is provided within a junction box such as an information box. The temperature recording part includes a memory for storing temperature and time signals. By virtue of this construction, the temperature within the junction box can be reliably recorded without undergoing the influence of any unfavorable phenomenon such as occurrence of noises in the course of the transmission of temperature signals, and the junction box provided remote from a control center or the like can be controlled based on the abnormality of the temperature within the junction box, whereby the junction box can be maintained in a normal state.

### TECHNICAL FIELD

The invention relates to a junction box, and more particularly to a junction box for conduit lines such as underground power lines, information boxes and the like, which can simply detect and control abnormality of temperature and the like even from a remote place.

### BACKGROUND ART

In recent years, high-speed, high-density information transmission lines using optical fibers or the like have become widely used. This has led to practical use of a conduit called an information box in which optical fibers or the like are installed in an underground space. A junction box is provided on the ground or underground in places of the information box for connection, branching or the like of communication lines. Further, a trend toward underground provision of power transmission lines, distribution lines and the like has led to the provision of junction boxes on the ground for connection, branching, inspection and the like. Upon the occurrence of an abnormal phenomenon, these junction boxes for electric power or communication sometimes cause a temperature rise due to heat generation within the boxes. Further, there is a fear that a rise in temperature to a value above an acceptable limit temperature due to a rise in external temperature, sunshine, a fire in the vicinity of the junction box and the like results in troubles in internal connection parts.

Conventional methods for coping with these drawbacks, that is, for detecting or monitoring an abnormal temperature rise derived from internal or external factors, include a method in which temperature sensors are provided in respective junction boxes and rounds of the junction boxes are made at any time or periodically for temperature inspection, and a method in which a temperature signal from a temperature sensor is sent to a monitor center either through a fixed line or wirelessly for continuous temperature monitoring in the center.

Continuous monitoring of temperature signals from the temperature sensor, not to mention the rounds for temperature inspection, requires workers responsible for this and thus are cost-ineffective. Instead of continuous monitoring of temperature signals, recording of temperature signals from the temperature sensors in a suitable storage means in the monitor center and reading (reproducing) data in the record of the temperature signals at predetermined time intervals for inspection for abnormal temperatures could significantly reduce the manpower for monitoring.

The method, in which the temperature signals from the temperature sensor are recorded in the storage means in the monitor center, however, is disadvantageous in that the occurrence of any unfavorable phenomenon in a communication line for connecting the temperature sensor to the monitor center may cause loss of at least a part of data in the record or occurrence of an error, in stored signals, causative of erroneous judgment. The unfavorable phenomenon is typically the occurrence of noises. Noises are very frequently generated by electric equipment, thunder, a change in the ionosphere, etc.

Accordingly, it is an object of the invention to realize a junction box, such as an information box, which can reliably record temperatures without undergoing the influence of any unfavorable phenomenon, such as noises, in the transmission of temperature signals, performs control based on the abnormality of the internal temperature, and can maintain a normal state.

### DISCLOSURE OF THE INVENTION

The junction box according to the invention includes: a temperature sensor for detecting the temperature of a predetermined site within the junction box to generate a temperature signal; a time signal generation means for generating a time signal; a recording means for storing the time signal and the temperature signal; and a transmission means for transmitting the temperature signal information stored in the recording means either through a fixed line or wirelessly. Said temperature sensor, said time signal generation means, said recording means, and said transmission means are integrally fixed in a temperature recording part. In the junction box according to the invention, preferably, the temperature recording part further includes a power source for the temperature sensor, the time signal generation means, the recording means, and the transmission means. The power source may comprise a single power unit. Alternatively, an additional power source(s) for at least one of the temperature sensor, the time signal generation means, the recording means, and the transmission means may be separately provided.

The junction box according to the present invention is particularly useful as a junction box for the connection (including branching; the same shall apply hereinafter) of optical fibers laid in an information box provided in an underground space.

### BRIEF DESCRIPTION OF THE DRAWINGS

FIG. 1 is an explanatory view of a typical information box;

FIG. 2 is an explanatory view of a junction box in an information box in an embodiment of the invention;

FIG. 3 is an explanatory view of a temperature recording device constituting a junction box in an information box according to the present invention;

FIG. 4 is a block diagram showing the construction of a temperature recording part in the temperature recording device shown in FIG. 3;

FIG. 5 is a block diagram showing the construction of a temperature detection part in the temperature recording part shown in FIG. 4; and

FIG. 6 is a block diagram showing the construction of a memory in the temperature detection part shown in FIG. 5.

### BEST MODE FOR CARRYING OUT THE INVENTION

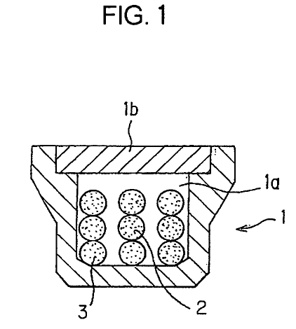

Embodiments of the invention will be described in detail in conjunction with the accompanying drawings. FIG. 1 is a cross-sectional view of a typical information box. An information box 1 has a hollow part 1a in its interior. The hollow part 1a contains civil optical fibers 2 and optical fibers 3 for the administration of roads. The hollow part 1a is covered with a lid 1b.

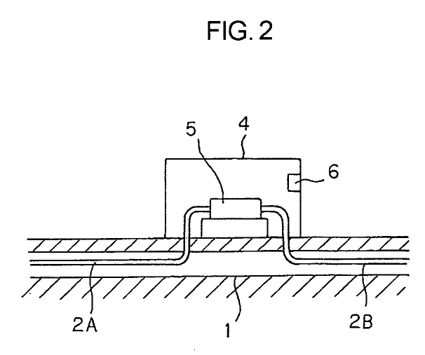

FIG. 2 shows a junction box, provided with a temperature recording part, in an information box according to the invention. A connection part 5, between an optical fiber 2A and an optical fiber 2B, and a temperature recording device 6 are provided within the junction box 4.

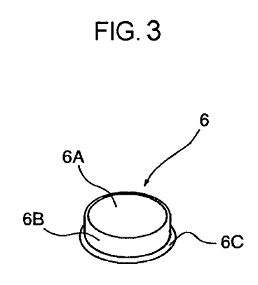

FIG. 3 shows a temperature recording device 6. The temperature recording device 6 includes a data input/output terminal 6A provided on the upper part of a button-type metallic case made of a stainless steel, a ground terminal 6B provided on the side face of the metallic case, and a collar part 6C provided on the bottom of the temperature recording device 6. A cell as a power source, a semiconductor chip for temperature measurement and communication with an external element, and a circuit board are provided in an electrically connected state within the metallic case. The inside of the metallic case is molded with a resin by filling the resin into the case for the prevention of shortcircuiting and for watertighting of circuit components housed in the case. This temperature recording device 6 is fixed within the information box 1 with the aid of a fixing member such as a screw, an adhesive, a tape or the like.

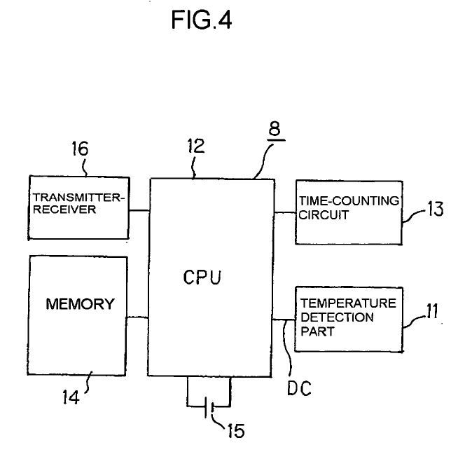

FIG. 4 is a block diagram showing the construction of a temperature recording part in a temperature recording device. The temperature recording part 8 includes a temperature detection part 11, a central processing unit (CPU) 12, a time-counting circuit 13 for supplying a time signal to CPU 12, a memory 14 for storing data such as measured temperatures, measured times, and an identification symbol of the junction box, a power source 15, and a receiving/transmitting device 16. The temperature detection part 11 includes a temperature sensor, a control circuit, a memory, and an input/output circuit. The temperature sensor utilizes a PN junction-type diode and detects the temperature by comparison with a reference voltage based on the dependency of the forward voltage upon the temperature.

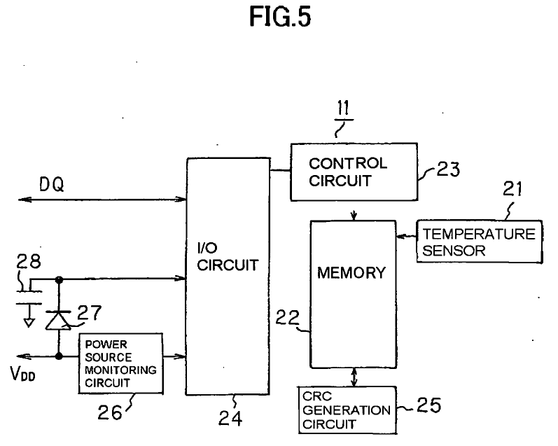

FIG. 5 is a block diagram showing the construction of a temperature detection part. The temperature detection part 11 includes a temperature sensor 21, a memory 22, a control circuit 23, an input/output circuit 24, a CRC generation circuit 25, a power source monitoring circuit 26, a rectifier 27, and a capacitor 28. The temperature sensor 21 generates digital temperature signals, for example, in 0.5° C. increments from −55° C. to 125° C. The input/output circuit 24 is connected to CPU 12 through a signal line DQ and functions to input and output data. The control circuit 23 controls the transmission of data such as temperature data in response to commands sent from CPU 12 and introduced through the input/output circuit 24. The power source monitoring circuit 26 detects the state of electric power supplied from the power source 15 through a power source line V_{DD}. The CRC generation circuit 25 generates CRC codes for checking data errors and sends the CRC codes to the memory 22 at the time of data transmission.

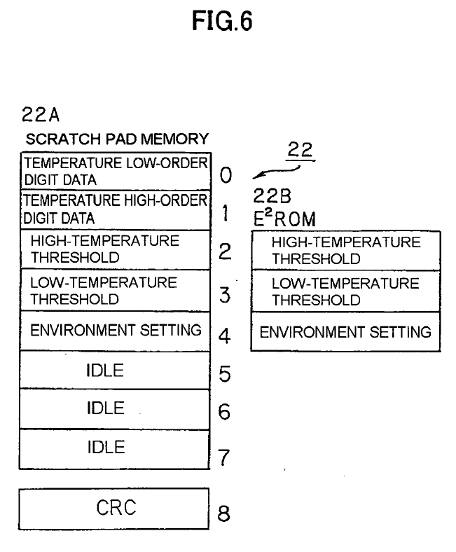

FIG. 6 is a block diagram showing the construction of a memory in the temperature detection part. The memory 22 includes a scratch pad memory 22A and E²ROM 22B. The scratch pad memory 22A is 8-byte RAM. Bytes 0-4 are used respectively for temperature low-order digit data, temperature high-order digit data, high-temperature threshold, low-temperature threshold, and environment setting data. The remaining three bytes are idle. The high-temperature threshold and the low-temperature threshold determine respectively the upper and lower temperature limits for a temperature alarm. The environment setting data determines the resolution of measurement temperature and the maximum temperature conversion time. E²ROM 22B is provided with registers respectively for the high-temperature threshold, the low-temperature threshold, and the environment setting and functions to input the high-temperature threshold, the low-temperature threshold, and the environment setting data into the scratch pad memory 22A.

Temperature signals sent from the temperature sensor 21 are stored in the byte for the temperature low-order digit data and the byte for the temperature high-order digit data in the scratch pad memory 22A under control by the control circuit 23. The temperature low-order digit data and the temperature high-order digit data are passed through the control circuit 23 and the input/output circuit 24 and is sent to the signal line DQ. When the temperature data indicates that the temperature is above the high-temperature threshold or below the low-temperature threshold, the alarm signal is output from the control circuit 23, is passed through the input/output circuit 24, and is sent to the signal line DQ. At the time of data transmission, the data are checked for error by taking advantage of CRC codes supplied from the CRC generation circuit 25. The temperature record data sent to the signal line DQ is combined with the corresponding time data and is if necessary transmitted as temperature progress data (for example, for each given time through a program stored on the memory 14, or in response to a command from a control center) from a transmitter-receiver 16 through radio waves to a control center (not shown). The alarm signal is also sent from the transmitter-receiver 16 to the control center. The transmission to the control center can be carried out by utilizing optical signals through an optical fiber.

As soon as the control center receives the temperature progress data, the data are indicated, on an image display, a recording paper or the like, in the form of a numeral data table, a graph or the like to make a judgment on whether the thermal state of the junction box in the information box is normal or abnormal. Upon the receipt of an alarm signal, taking measures to the abnormal phenomenon can be undertaken. When an unfavorable phenomenon such as the occurrence of noises has occurred at the time of transmission from the junction box to the control center, the following method may be adopted. As soon as the unfavorable phenomenon has been eliminated, a signal for requesting the retransmission can be sent from the control center to the transmitter-receiver in the junction box to again obtain the temperature progress data.

In the above embodiment, a construction, in which the temperature recording device 6 has been fixed on the inner wall part of the information box 1 for temperature measurement purposes, has been explained. However, it should be noted that, for example, the temperature recording device 6 may be fixed onto the connection part 5 with the aid of a fixing member to directly measure the temperature of the connection part 5. Further, a construction may be adopted wherein two temperature recording devices 6 are provided within the information box 1 to measure with fear the temperature of the hollow part 1a and the temperature of the connection part 5. According to this construction, the abnormality of the temperature within the information box 1 can be grasped with high accuracy. This contributes to stable operation of communication lines.

As is apparent from the foregoing description, according to the junction box of the invention, a temperature recording part is provided within a junction box for an information box or the like. The temperature recording part includes a recording means for storing temperature and time signals. By virtue of this construction, the temperature within the junction box can be reliably recorded without undergoing the influence of any unfavorable phenomenon such as occurrence of noises in the course of the transmission of temperature signals, and the junction box provided remote from a control center or the like can be controlled based on the abnormality of the temperature within the junction box, whereby the junction box can be maintained in a normal state.

### INDUSTRIAL APPLICABILITY

As described above, the junction box of the invention is suitable for the control of temperature abnormality as a junction box for an information box or the like in which underground power lines, optical fibers or the like are laid.

1. A junction box for power lines, communication lines or the like, characterized by comprising:
a temperature sensor for detecting the temperature of a predetermined site within the junction box to generate a temperature signal;
a time signal generation means for generating a time signal;
a recording means for storing the time signal and the temperature signal; and
a transmission means for transmitting the temperature signal information stored in the recording means either through a fixed line or wirelessly,
said temperature sensor, said time signal generation means, said recording means, and said transmission means being integrally fixed in a temperature recording part.

2. The junction box as defined in claim 1, wherein said recording means stores said temperature signal in a correlation with the time signal at the time of the detection of the temperature signal.

3. The junction box as defined in claim 1, wherein said junction box is used for the connection of optical fibers.

4. The junction box as defined in claim 3, wherein said optical fibers are laid in an information box provided in an underground space.

5. The junction box as defined in claim 1, wherein said junction box is used for the connection of power lines.

6. The junction box as defined in claim 5, wherein said junction box is used for the connection of power lines which have been laid underground.

7. A junction box for power lines, communication lines or the like, characterized by comprising:
a temperature sensor for detecting the temperature of a predetermined site within the junction box to generate a temperature signal;
a time signal generation means for generating a time signal;
a recording means for storing the time signal and the temperature signal;
a transmission means for transmitting the temperature signal information stored in the recording means either through a fixed line or wirelessly; and
a power source for said temperature sensor, said time signal generation means, said recording means, and said transmission means,
said temperature sensor, said time signal generation means, said recording means, said transmission means, and said power source being integrally fixed in a temperature recording part.

8. The junction box as defined in claim 7, wherein said recording means stores said temperature signal in a correlation with the time signal at the time of the detection of the temperature signal.

9. The junction box of claim 8, wherein said junction box is used for the connection of optical fibers laid in an information box provided in an underground space.

10. The junction box as defined in claim 2, wherein said junction box is used for the connection of optical fibers.

11. The junction box as defined in claim 2, wherein said junction box is used for the connection of power lines.
